(19) United States
(12) Patent Application Publication
(10) Pub. No.: US 2021/0229518 A1
(43) Pub. Date: Jul. 29, 2021

(54) VEHICLE KNUCKLE AND MANUFACTURING METHOD THEREOF

(71) Applicant: ILJIN CO., LTD., Gyeongju-si Gyeongsangbuk-do (KR)

(72) Inventors: Se Woong JEONG, Ulsan (KR); Ig Jin KWON, Daegu (KR); Young Chun LEE, Suwon (KR)

(73) Assignee: ILJIN CO., LTD., Gyeongju-si Gyeongsangbuk-do (KR)

(21) Appl. No.: 17/157,095

(22) Filed: Jan. 25, 2021

(30) Foreign Application Priority Data
Jan. 23, 2020 (KR) 10-2020-0009465

(51) Int. Cl. B60G 21/05; B60G 7/00

(52) U.S. Cl. CPC B60G 21/052; B60G 7/001; B60G 7/008; B60G 2204/418; B60G 2204/148; B60G 2204/41; B60G 2200/464

(57) ABSTRACT

According to one embodiment of the present disclosure, a vehicle knuckle used in a steering device of a vehicle is provided. The vehicle knuckle according to one embodiment of the present disclosure may comprise a knuckle body constituting a basic body of the vehicle knuckle; and one or more flanges formed on one side of the knuckle body and configured to be used to connect the knuckle to other components of the vehicle. According to one embodiment of the present disclosure, all or a portion of the knuckle body may comprise a closed-box-section structure in which a hollow space portion is defined, and the closed-box-section structure may be configured such that the knuckle body integrally encloses around the hollow space portion.

### CROSS-REFERENCE TO RELATED APPLICATIONS

This application claims priority to Korean Patent Application No. 10-2020-0009465 filed on Jan. 23, 2020, the entire contents of which are herein incorporated by reference.

### TECHNICAL FIELD

The present disclosure relates to a vehicle knuckle used in a steering device of a vehicle and a method of manufacturing the same, more particularly, to a vehicle knuckle capable of being easily manufactured while implementing a reduction in weight and an increase in rigidity by forming a hollow closed-box-section structure whose interior is empty in a knuckle body and a method of manufacturing the same.

### BACKGROUND ART

A vehicle knuckle is a component that constitutes a steering device of a vehicle, and is coupled to a wheel bearing that rotatably mounts and supports a wheel to a vehicle axis so as to perform a function of controlling the driving direction of the vehicle.

Typically, the vehicle knuckle may be formed to comprise a knuckle body and flanges provided around the knuckle body. The knuckle body may be formed such that a wheel bearing mounting portion is provided in the central portion thereof. The flanges (for example, a caliper mounting flange to which a brake caliper is coupled, a tie rod mounting flange to which a tie rod is coupled, a suspension arm mounting flange to which a suspension arm is coupled, a strut mounting flange to which a strut assembly is coupled, and the like) may be used to connect the knuckle to other components of the vehicle. Further, such a vehicle knuckle may be formed by molding metallic material using a casting process or the like in order for providing sufficient rigidity required for vehicular components.

However, in a case that the vehicle knuckle is formed using metallic material such as steel material (e.g., chromium-molybdenum alloy steel) or aluminum material, the overall weight of the vehicle knuckle is increased due to the weight of the metallic material. This causes a problem that is difficult to meet a weight-reducing trend required for vehicular components.

### SUMMARY

### Technical Problem

The present disclosure is to solve the above-mentioned problem related to a vehicle knuckle, and is to provide a vehicle knuckle capable of being more easily manufactured while implementing a reduction in weight and sufficiently ensuring rigidity required for vehicular components by forming a hollow closed-box-section structure whose interior is empty in a knuckle body and a method of manufacturing such a vehicle knuckle.

### Technical Solution

Representative configurations of the present disclosure for achieving the above object are as follows.

According to one embodiment of the present disclosure, a vehicle knuckle used in a steering device of a vehicle is provided. The vehicle knuckle according to one embodiment of the present disclosure may comprise a knuckle body constituting a basic body of the vehicle knuckle; and one or more flanges formed on one side of the knuckle body and configured to be used to connect the knuckle to other vehicular components. According to one embodiment of the present disclosure, all or a portion of the knuckle body may comprise a closed-box-section structure in which a hollow space portion is defined, and the closed-box-section structure may be configured such that the knuckle body integrally encloses around the hollow space portion.

According to one embodiment of the present disclosure, at least one reinforcement rib may be provided in the hollow space portion.

According to one embodiment of the present disclosure, the reinforcement rib may be formed in a bar shape extending from one side of an inner circumferential surface of the hollow space portion to another side of the inner circumferential surface of the hollow space portion.

According to one embodiment of the present disclosure, the reinforcement rib may be formed in the bar shape extending at an angle ranging from 5 degrees to 175 degrees with respect to the inner circumferential surface of the hollow space portion.

According to one embodiment of the present disclosure, a plurality of reinforcement ribs may be provided in the hollow space portion, and the plurality of reinforcement ribs may be configured to form a lattice structure in the hollow space portion.

According to one embodiment of the present disclosure, the knuckle body and the one or more flanges may be formed to have a single integrated structure.

According to one embodiment of the present disclosure, the vehicle knuckle may be formed by injecting molten metallic material into a mold in a state that the sand core formed to have a structure corresponding to the hollow space portion is mounted in the mold.

According to one embodiment of the present disclosure, the molten metallic material injected to form the vehicle knuckle may be molten aluminum material.

According to one embodiment of the present disclosure, a method of manufacturing a vehicle knuckle used in a steering device of a vehicle is provided. The vehicle knuckle manufacturing method according to one embodiment of the present disclosure may comprise: a sand core preparation step of preparing a sand core used for molding a knuckle; a sand core mounting and knuckle molding step of mounting the sand core in a mold and then injecting molten metallic material into the mold to mold the knuckle; a separating step of separating the molded knuckle from the mold; and a sand removal step of removing the sand core adhering to the separated knuckle.

According to one embodiment of the present disclosure, in the sand core preparation step, the sand core may be formed to have at least one through-hole for forming at least one reinforcement rib, and the reinforcement rib may be formed to extend from one side of an inner circumferential surface of a hollow space portion to another side of the inner circumferential surface of the hollow space portion by the molten metallic material introduced into the at least one through-hole.

According to one embodiment of the present disclosure, in the sand core preparation step, the sand core may be formed by a 3D printer.

According to one embodiment of the present disclosure, the sand core mounting and knuckle molding step may comprise mounting the sand core in a recess provided in a lower mold and having a shape corresponding to the vehicle knuckle; covering the lower mold with an upper mold; and injecting the molten metallic material into the mold to form the knuckle.

According to one embodiment of the present disclosure, the molten metallic material injected in the sand core mounting and knuckle molding step may be molten aluminum material.

According to one embodiment of the present disclosure, in the sand removal step, the removal of the sand core may be performed using any one of a vibration mode of applying vibration to remove the sand core, an air injection mode of injecting air to remove the sand core, and a solvent immersion mode of immersing a product in a solution that can melting the sand core to remove the sand core.

In addition, the vehicle knuckle and the manufacturing method thereof according to the present disclosure may further comprise other additional configurations without departing from the technical sprit of the present disclosure.

### Advantageous Effects

Since the vehicle knuckle according to one embodiment of the present disclosure is configured such that a hollow closed-box-section structure whose interior is empty is formed in a knuckle body, it is possible to implement a reduction in weight through the hollow structure and to have sufficient rigidity required for vehicular components through the closed-box-section structure.

Further, since the vehicle knuckle according to one embodiment of the present disclosure may be manufactured through a sand casting process using a sand core, it is possible to form a complete hollow closed-box-section structure in the knuckle body without performing welding over a wide range. As a result, the vehicle knuckle according to one embodiment of the present disclosure can have a high level of rigidity while implementing a reduction in weight, compared to conventional vehicle knuckles.

Furthermore, since the vehicle knuckle according to one embodiment of the present disclosure has a configuration in which at least one reinforcement rib (preferably reinforcement ribs formed to have a lattice structure) is provided inside the knuckle body having a hollow closed-box-section structure. Thus, it is possible to further improve the rigidity of the knuckle formed to have the hollow closed-box-section structure.

### DESCRIPTION OF DRAWINGS

FIG. 1 exemplarily illustrates an overall configuration of a vehicle knuckle according to one embodiment of the present disclosure.

FIG. 2 exemplarily shows a partially broken away perspective view of the vehicle knuckle according to one embodiment of the present disclosure.

FIG. 3 exemplarily shows a cross-sectional structure of the vehicle knuckle according to one embodiment of the present disclosure, taken along line A-A in FIG. 2.

FIG. 4 exemplarily shows a manufacturing process flowchart that can be used to manufacture the vehicle knuckle according to one embodiment of the present disclosure.

FIG. 5 exemplarily shows a configuration of a sand core that can be used to manufacture the vehicle knuckle according to one embodiment of the present disclosure.

FIG. 6 exemplarily shows a process of mounting the sand core in a mold to form a knuckle in the manufacturing method of the vehicle knuckle according to one embodiment of the present disclosure.

FIG. 7 exemplarily shows a process of forming the vehicle knuckle according to one embodiment of the present disclosure by separating a molded knuckle product from the mold, removing the sand core from the molded knuckle product, and then performing finish machining.

### DETAILED DESCRIPTION

Hereinafter, preferred embodiments of the present disclosure will be described in detail with reference to the appended drawings to such an extent that the present disclosure can be readily practiced by one of ordinary skill in the art.

Detailed descriptions of parts irrelevant to the present disclosure will be omitted for the purpose of more clearly describing the present disclosure. Throughout the specification, the same or similar components will be described using same or similar reference numerals. In addition, the sizes, thicknesses, positions, and the like of the respective components shown in the drawings are arbitrarily illustrated for the sake of convenience of explanation, and hence the present disclosure is not necessarily limited thereto. That is, it should be understood that specific shapes, configurations, and characteristics described in the specification may be modified in various embodiments without departing from the spirit and scope of the prevent disclosure, and positions or arrangements of individual components may be modified without departing from the spirit and scope of the prevent disclosure. Therefore, detailed descriptions to be described below should be construed as non-limitative senses, and the scope of the prevent disclosure should be understood to include the scope of the appended claims and all equivalents thereof.

Vehicle Knuckle According to One Embodiment of the Present Disclosure

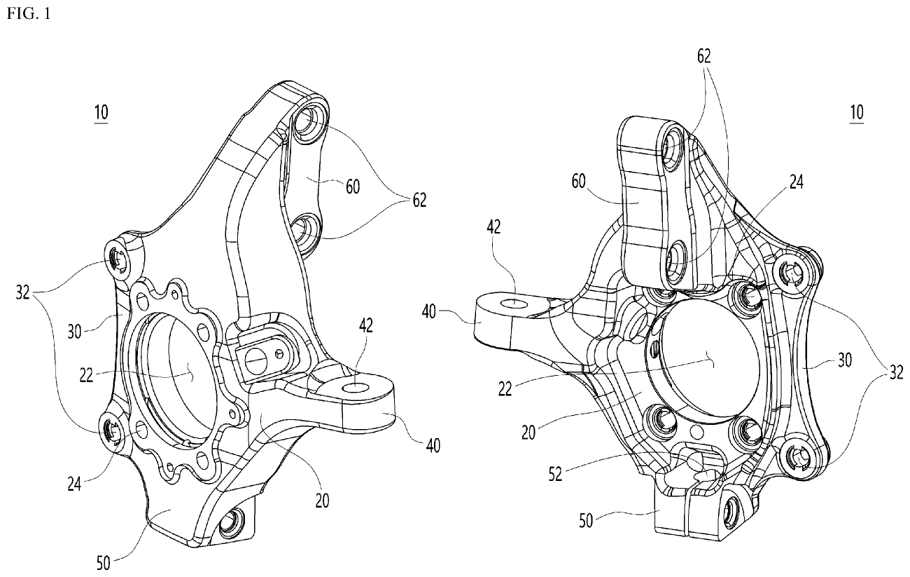

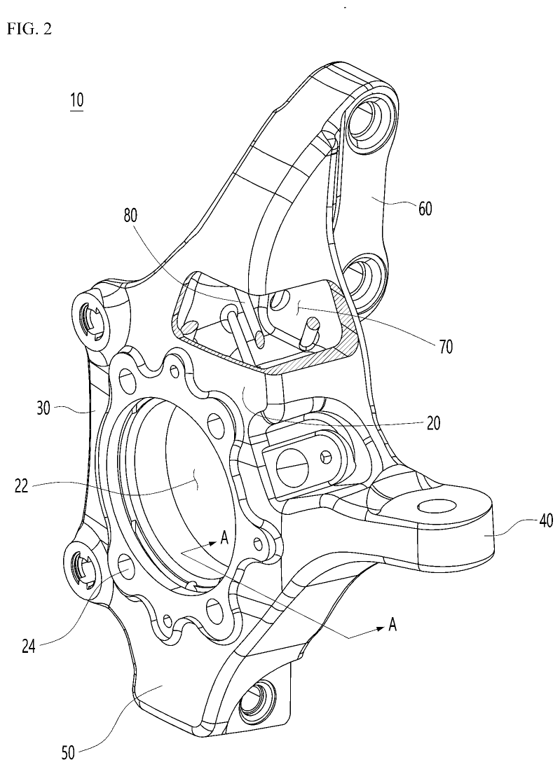

Referring to FIGS. 1 and 2, an overall configuration of a vehicle knuckle 10 according to one embodiment of the present disclosure is exemplarily shown. As shown in the drawings, the vehicle knuckle 10 according to one embodiment of the present disclosure may be formed to have a configuration similar to a conventional vehicle knuckle. For example, the vehicle knuckle 10 according to one embodiment of the present disclosure may be configured to comprise a knuckle body 20 located in the central portion of the vehicle knuckle and one or more flanges (e.g., a first flange 30, a second flange 40, a third flange 50, a fourth flange 60, and the like) provided on one side of the knuckle body 20 and used to connect the knuckle with other components of the vehicle.

According to one embodiment of the present disclosure, the knuckle body 20 may constitute a basic body of the knuckle and may be configured such that a wheel bearing mounting hole 22 is formed to penetrate the central portion of the knuckle body 20 and a wheel bearing (not shown) is inserted into and mounted to the wheel bearing mounting hole 22. Further, one or more fastening holes 24 may be provided around the wheel bearing mounting hole 22 to fix the wheel bearing (not shown) to the knuckle body 20 via fastening bolts or the like.

According to one embodiment of the present disclosure, the first flange 30 is a part to which a brake caliper is coupled, and may be formed to extend along one side of the knuckle body 20. According to one embodiment of the present disclosure, the first flange 30 may be provided with at least one fastening hole 32 into which a caliper bushing is inserted. The knuckle may be connected to the brake caliper via the first flange 30.

According to one embodiment of the present disclosure, the second flange 40 is a part to which a tie rod is coupled, and may be formed in a direction generally perpendicular to a plane of the knuckle body 20 on one side of the knuckle body 20. According to one embodiment of the present disclosure, the second flange 40 may be provided with at least one fastening hole 42 into which a tie rod bushing is inserted. The knuckle may be connected to the tie rod via the second flange 40.

According to one embodiment of the present disclosure, the third flange 50 is a part to which a suspension arm (for example, a lower arm) constituting a suspension system is coupled, and may be formed in a direction generally perpendicular to the plane of the knuckle body 20 on one side of the knuckle body 20. According to one embodiment of the present disclosure, the third flange 50 may be provided with at least one fastening hole 52 into which a suspension arm bushing is inserted. The knuckle may be connected to the suspension arm via the third flange 50.

According to one embodiment of the present disclosure, the fourth flange 60 is a part to which a strut assembly constituting the suspension system is coupled, and may be formed in a direction generally perpendicular to a plane of the knuckle body 20 on one side of the knuckle body 20. According to one embodiment of the present disclosure, the fourth flange 60 may be provided with at least one fastening hole 62 into which a strut bushing is inserted. The knuckle may be connected to the strut assembly via the fourth flange 60.

The embodiments shown in the drawings are exemplarily illustrated to describe the vehicle knuckle 10 according to one embodiment of the present disclosure, and the vehicle knuckle 10 according to one embodiment of the present disclosure is not necessarily limited to have the configurations shown in the drawings. The vehicle knuckle 10 according to one embodiment of the present disclosure may be formed to have other modified configurations.

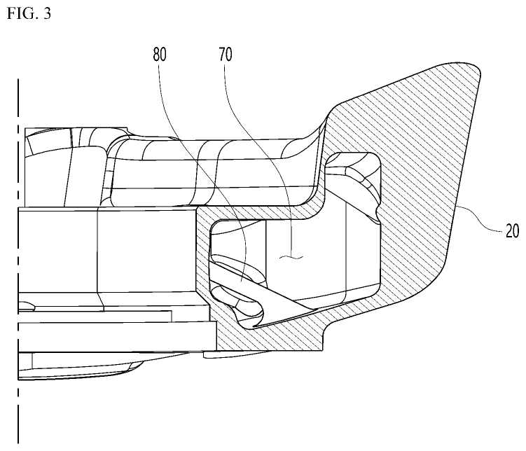

According to one embodiment of the present disclosure, all or a portion of the knuckle body 20 may have a hollow closed-box-section structure whose interior is empty. For example, the vehicle knuckle 10 according to one embodiment of the present disclosure may be formed such that a hollow space portion 70 is formed inside the knuckle body 20 and the hollow space portion 70 is entirely enclosed by the knuckle body 20 so as to form a complete hollow closed-box-section structure, as shown in FIGS. 2 and 3.

With this configuration, since the vehicle knuckle 10 according to one embodiment of the present disclosure has the configuration in which the knuckle body constituting the basic body has a hollow structure, it is possible to reduce the overall weight of the knuckle. Further, the vehicle knuckle 10 according to one embodiment of the present disclosure can sufficiently meet the rigidity requirement required for the vehicle knuckle by the closed-box-section structure, even if the hollow structure is formed in the knuckle body.

In the meantime, according to one embodiment of the present disclosure, the flanges (e.g., the first flange 30, the second flange 40, the third flange 50, the fourth flange 60, and the like) provided on one side of the knuckle body 20 may be configured to have a solid structure whose interior is completely filled to secure stable fastening with counter parts, unlike the knuckle body 20.

Unlike the above embodiments illustrated in the drawings, the vehicle knuckle 10 according to one embodiment of the present disclosure may be configured so that the flanges formed on one side of the knuckle body 20 also have the closed-box-section structure in which a hollow space portion is defined, according to a specific design requirement of the knuckle.

According to one embodiment of the present disclosure, at least one reinforcement rib 80 may be provided in the hollow space portion 70 formed by the closed-box-section structure. According to one embodiment of the present disclose, the reinforcement rib 80 may be formed to extend from one side of an inner circumferential surface of the hollow space portion 70 to another side of the inner circumferential surface of the hollow space portion 70.

For example, the reinforcement rib 80 may be formed in a bar shape extending from one side to another side on the inner circumferential surface of the hollow space portion 70 (see FIGS. 2 and 3). Further, a plurality of reinforcement ribs 80 may be provided in the hollow space portion 70 to form a complex lattice structure inside the hollow space portion 70.

According to one embodiment of the present disclosure, the reinforcement rib 80 may be formed as various cross-sectional structures, such as cylindrical, polygonal, or the like. In order to ensure sufficient rigidity, the reinforcement rib 80 may be formed to extend at an angle ranging from 5 degrees to 175 degrees with respect to the inner circumferential surface on which the reinforcement rib 80 is to be formed.

When the reinforcement ribs 80 are provided in the hollow space portion 70 formed by the closed-box-section structure as described above, the rigidity of the knuckle can be complemented by the reinforcement rib 80. As a result, even if the hollow structure is formed in the knuckle body 20, the knuckle can have stable rigidity.

According to one embodiment of the present disclosure, the vehicle knuckle 10 with the above-described configuration may be configured to be formed by a sand casting process, and may be formed such that the knuckle body 20 and the flanges (e.g., the first flange 30, the second flange 40, the third flange 50, the fourth flange 60, and the like) formed on one side of the knuckle body 20 may be formed as a single integrated unit.

Specifically, the vehicle knuckle 10 according to one embodiment of the present disclosure may be formed through the sand casting process using a sand core 90. A method of manufacturing the vehicle knuckle 10 according to one embodiment of the present disclosure through the sand casting process using the sand core 90 will be described in detail below.

Vehicle Knuckle Manufacturing Method According to One Embodiment of the Present Disclosure

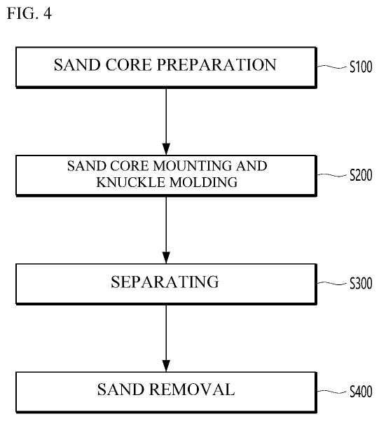

Referring to FIG. 4, there is exemplarily shown a flowchart for explaining a vehicle knuckle manufacturing method according to one embodiment of the present disclosure. As shown in FIG. 4, the vehicle knuckle manufacturing method according to one embodiment of the present disclosure may comprise a sand core preparation step S100 of preparing a sand core used for molding knuckle; a sand core mounting and knuckle molding step S200 of mounting the sand core in a mold and then injecting molten metallic material into the mold to mold (form) the vehicle knuckle; a separating step S300 of separating the molded knuckle from the mold; and a sand removal step S400 of removing the sand core adhering to the separated knuckle to form the knuckle, and the like.

According to one embodiment of the present disclosure, the sand core preparation step S100 is a step of forming an inner core body which is used for forming the vehicle knuckle 10 according to one embodiment of the present disclosure through a sand casting process, wherein the sand core 90 may be formed in a shape corresponding to the hollow space portion 70 provided in the vehicle knuckle 10 according to one embodiment of the present disclosure.

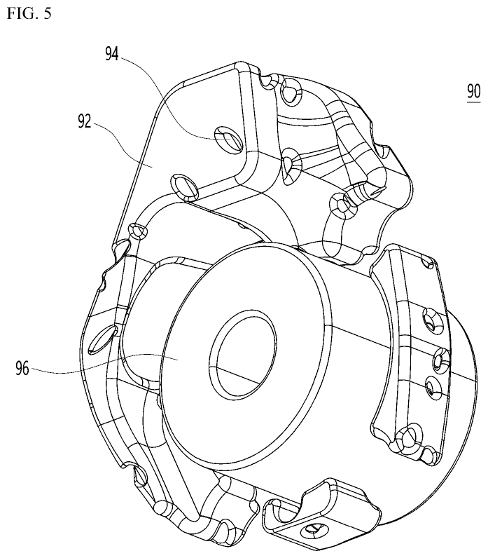

For example, since the sand core 90 is formed in a shape that matches the hollow space portion 70 provided in the vehicle knuckle 10 according to one embodiment of the present disclosure as shown in FIG. 5, when molten metal such as aluminum is injected in a subsequent step, the injected metal flows to enclose an outer circumferential surface of the sand core 90 to form the vehicle knuckle 10 according to one embodiment of the present disclosure.

Specifically, the sand core 90 may be provided with a body portion 92 having a shape entirely corresponding to the hollow space portion 70. The body portion 92 may have at least one through-hole 94. In a subsequent knuckle molding step, the molten metal may be filled in the through-hole 94 to form the reinforcement rib 80 in the hollow space portion 70. In the meantime, the body portion 92 may have a protruded central portion 96, which corresponds to the wheel bearing mounting hole 22 provided in the knuckle body 20, such that the penetrated wheel bearing mounting hole 22 may be formed at the central portion of the knuckle body 20 by the protruded central portion 96.

However, the sand core 90 is not limited to being formed in the configuration illustrated in the drawings, and may be modified in various ways depending on a structure of the vehicle knuckle 10 to be manufactured and a structure of the hollow space portion 70 provided in the vehicle knuckle 10.

According to one embodiment of the present disclosure, the sand core 90 may be manufactured using a 3D printer so as to be able to easily form in a shape-optimized manner a complex structure that a plurality of through-holes 94 for forming the reinforcement rib 80 are provided.

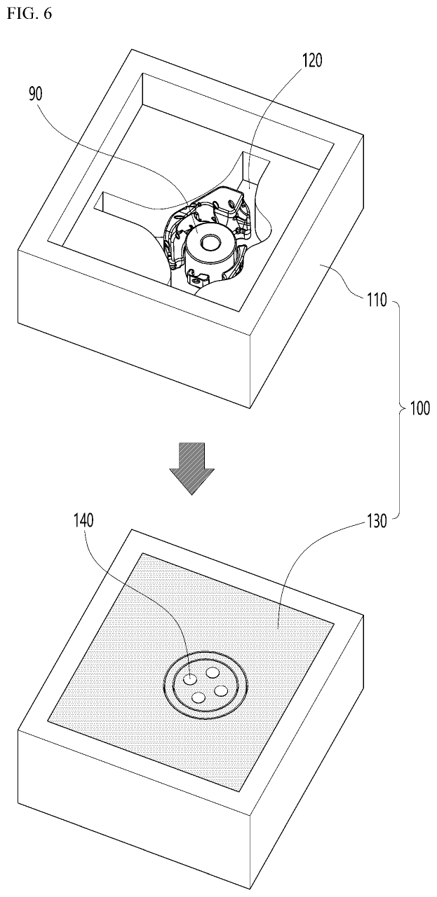

Next, the sand core mounting and knuckle molding step S200 is a step of forming the vehicle knuckle 10 according to one embodiment of the present disclosure by placing the sand core 90 in a mold 100 prepared in advance and then injecting the molten metal into the mold 100. For example, the sand core mounting and knuckle molding step S200 may comprise inserting the sand core 90 into a lower mold 110 having a recess 120 having a shape corresponding to the vehicle knuckle to be manufactured such that the sand core 90 is mounted inside the lower mold 110; covering the lower mold 110 with an upper mold 130; and injecting the molten metal such as aluminum into the mold through an inlet 140 to form the knuckle, as shown in FIG. 6.

Next, the separating step S300 is a step of separating the molded knuckle product from the mold. In this step, the molded knuckle product may be separated from the mold in a state that the sand core 90 is adhered to the molded knuckle product.

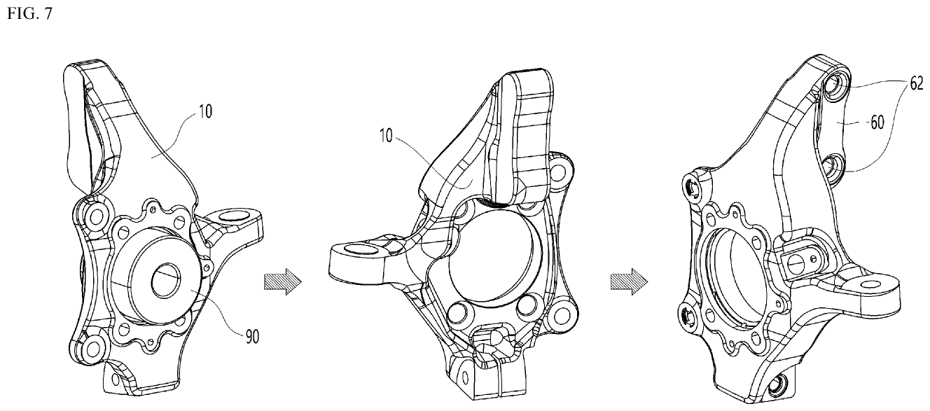

Next, the sand removal step S400 is a step of removing the sand core 90 from the separated knuckle product (the molded knuckle product to which the sand core is adhered; see an first figure in FIG. 7) and leaving only the knuckle (see a middle figure in FIG. 7). According to one embodiment of the present disclosure, the sand removal step may be performed using a vibration mode of applying vibration through a conveyor or the like to remove the sand core, an air injection mode of injecting air through the through-hole formed in the knuckle to remove the sand core, a solvent immersion mode of immersing a product in a solution, which can melt the sand core, to remove the sand core, and the like.

In the meantime, if necessary, a post-processing, such as trimming or machining, may be performed after the separating step and the sand removal step so as to form the vehicle knuckle in a designed final configuration and to perform a subsequent process needed for the vehicle knuckle (e.g., machining a strut bushing mounting hole on the fourth flange (strut mounting flange) that is not formed in the sand casting) (see a lower view in FIG. 7).

As described above, when the vehicle knuckle 10 is formed by a sand casting process using a sand core 90, it is possible to easily form the vehicle knuckle 10 having a complete closed-box-section structure in which the hollow space portion 70 is defined, like in the vehicle knuckle 10 according to the above-described embodiment of the present disclosure. This makes it possible to manufacture a vehicle knuckle that can meet the rigidity requirement required for vehicular components while reducing the weight of the product and simplifying the manufacturing process.

Furthermore, according to the above-described manufacturing method, it is possible to form a complete closed-box-section structure in the knuckle body 20 of the vehicle knuckle 10 and to integrally form the reinforcement rib 80 to extend from one side to another side on the inner circumferential surface of the hollow space portion 70 formed by the closed-box-section structure. This further improves the rigidity of the vehicle knuckle.

While the present disclosure has been described above by way of particular features such as specific components and the like, and exemplary embodiments, these embodiments are provided to further facilitate overall understanding of the present disclosure, and the present disclosure is not limited thereto. Various modifications and variations may be made from the above descriptions by those skilled in the art.

Therefore, the spirit of the present disclosure should not be limited to the above-described embodiments, and not only the append claims but also all those modified equally or equivalently to the claims are intended to fall within the scope of the spirit of the present disclosure.

### DESCRIPTION OF REFERENCE NUMERALS

10: vehicle knuckle
20: knuckle body
22: wheel bearing mounting hole
24: fastening hole
30: first flange
32: fastening hole (of the first flange)
40: second flange
42: fastening hole (of the second flange)
50: third flange
52: fastening hole (of the third flange)
60: fourth flange
62: fastening hole (of the fourth flange)
70: hollow space portion
80: reinforcement rib
90: sand core
92: body portion (of the sand core)
94: through-hole (formed in the sand core)
96: protruded portion (formed in the sand core)
100: mold
110: lower mold
120: recess
130: upper mold
140: inlet

What is claimed is:

1. A vehicle knuckle used in a steering device of a vehicle, comprising:
a knuckle body constituting a basic body of the vehicle knuckle; and
one or more flanges formed on one side of the knuckle body and configured to connect the vehicle knuckle to other vehicular components,
wherein all or a portion of the knuckle body has a closed-box-section structure in which a hollow space portion is defined, and
wherein the closed-box-section structure is configured such that the knuckle body integrally encloses around the hollow space portion.

2. The vehicle knuckle of claim 1, wherein at least one reinforcement rib is provided in the hollow space portion.

3. The vehicle knuckle of claim 2, wherein the reinforcement rib is formed in a bar shape extending from one side of an inner circumferential surface of the hollow space portion to another side of the inner circumferential surface of the hollow space portion.

4. The vehicle knuckle of claim 3, wherein the reinforcement rib is formed in the bar shape extending at an angle ranging from 5 degrees to 175 degrees with respect to the inner circumferential surface of the hollow space portion.

5. The vehicle knuckle of claim 4, wherein a plurality of reinforcement ribs are provided in the hollow space portion, and the plurality of reinforcement ribs are configured to form a lattice structure in the hollow space portion.

6. The vehicle knuckle of claim 4, wherein the knuckle body and the one or more flanges are formed to have a single integrated structure.

7. The vehicle knuckle of claim 6, wherein the vehicle knuckle is formed by injecting molten metallic material into a mold in a state that a sand core formed to have a structure corresponding to the hollow space portion is mounted in the mold.

8. The vehicle knuckle of claim 7, wherein the molten metallic material injected to form the vehicle knuckle is a molten aluminum material.

9. A method of manufacturing a vehicle knuckle used in a steering device of a vehicle, the method comprising:
a sand core preparation step of preparing a sand core used for molding a knuckle;
a sand core mounting and knuckle molding step of mounting the sand core in a mold and then injecting molten metallic material into the mold to mold the knuckle;
a separating step of separating the molded knuckle from the mold; and
a sand removal step of removing the sand core adhering to the separated knuckle.

10. The method of claim 9, wherein in the sand core preparation step, the sand core is formed to have at least one through-hole for forming at least one reinforcement rib, and the reinforcement rib is formed to extend from one side of an inner circumferential surface of a hollow space portion to another side of the inner circumferential surface of the hollow space portion by the molten metallic material introduced into the at least one through-hole.

11. The method of claim 10, wherein in the sand core preparation step, the sand core is formed by a 3D printer.

12. The method of claim 9, wherein the sand core mounting and knuckle molding step comprises:
mounting the sand core in a recess provided in a lower mold and having a shape corresponding to the vehicle knuckle;
covering the lower mold with an upper mold; and
injecting the molten metallic material in the mold to form the knuckle.

13. The method of claim 12, wherein the molten metallic material injected in the sand core mounting and knuckle molding step is molten aluminum material.

14. The method of claim 9, wherein in the sand removal step, the removal of the sand core is performed using any one of a vibration mode of applying vibration to remove the sand core, an air injection mode of injecting air to remove the sand core, and a solvent immersion mode of immersing a product in a solution that can melting the sand core to remove the sand core.
